(19) United States
(12) Patent Application Publication
(10) Pub. No.: US 2010/0060141 A1
(43) Pub. Date: Mar. 11, 2010

(54) ELECTRON BEAM DEVICE AND IMAGE DISPLAY APPARATUS USING THE SAME

(75) Inventors: Ouichi Kubota, Atsugi-shi (JP); Noritake Suzuki, Hiratsuka-shi (JP); Hideshi Kawasaki, Machida-shi (JP); Tamaki Kobayashi, Isehara-shi (JP); Toshihiko Takeda, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/553,727

(22) Filed: Sep. 3, 2009

(30) Foreign Application Priority Data
Sep. 9, 2008 (JP) 2008-231028

(51) Int. Cl. H01J 1/62; H01J 1/02

(52) U.S. Cl. 313/496; 313/235

(57) ABSTRACT

In an electron beam device employing an electron-emitting device in which a gate and a cathode are provided to sandwich a recess portion formed on an insulating member, electrons are scattered after the collision against the gate and then extracted, it is made possible to easily obtain stable electron emission characteristics and also to prevent the electron-emitting device from being deteriorated or being fractured due to overheating even when an excessive heat has been generated. The electron-emitting device includes the cathode having a protrusion 30 positioned astride the outer surface of the insulating member and the inner surface of the recess portion formed in the insulating member, and the gate including a layered structure of at least two electroconductive layers. A thermal expansion coefficient of the electroconductive layer which is arranged at a part facing to the protrusion is larger than that of the other electroconductive layer.

### BACKGROUND OF THE INVENTION

1. Field of the Invention

The present invention relates to an electron beam device for emitting electrons, and an image display apparatus using the same.

2. Description of the Related Art

Conventionally, an electron-emitting device is known which makes a large number of electrons emitted from a cathode, collide against a facing gate and be scattered therein, and then extracts the electrons. A surface conduction type of electron-emitting device and a stacked type of electron-emitting device are known as devices which emit electrons in such a form. Japanese Patent Application Laid-Open No. 2001-167693 discloses a stacked type of electron-emitting device having a structure in which a recess portion is provided in an insulating layer in the vicinity of the electron-emitting portion.

Japanese Patent Application Laid-Open No. 2001-43789 discloses a Spindt-type of electron-emitting device which has a completely different structure and form of extracting electrons from the above described electron-emitting device that makes electrons collide against a gate and be scattered therein and then extracts the electrons, and which employs a layered structure of electroconductive layers for its gate. Specifically, it is disclosed that the gate includes a first electroconductive layer and a second electroconductive layer stacked on the first electroconductive layer, and that a coefficient of linear thermal expansion of the second electroconductive layer is made to be smaller than the coefficient of linear thermal expansion of the first electroconductive layer.

### SUMMARY OF THE INVENTION

An object of the present invention is to enable an electron beam device with the use of an electron-emitting device which makes electrons collide against a gate and be scattered therein and then extracts the electrons, to easily obtain stable electron emission characteristics and also to prevent the electron-emitting device from being deteriorated or being fractured due to overheating even when an excessive heat has been generated therein.

In order to achieve the above described object, the present invention provides an electron beam device including: an insulating member having a recess portion on a surface of the insulating member; a cathode having a protrusion extending over an outer surface of the insulating member and an inner surface of the recess portion; a gate arranged on the outer surface of the insulating member, the gate facing the protrusion; and an anode facing the protrusion via the gate, wherein the gate includes a layered structure having at least two electroconductive layers, and a thermal expansion coefficient of one of the electroconductive layers that is arranged at a part facing the protrusion is larger than a thermal expansion coefficient of rest of the electroconductive layers.

The present invention can provide an electron-emitting device which keeps stable electron emission characteristics for a long period of time.

Further features of the present invention will become apparent from the following description of exemplary embodiments with reference to the attached drawings.

### BRIEF DESCRIPTION OF THE DRAWINGS

FIGS. 1A, 1B and 1C are schematic views of an electron-emitting device according to a first example of the present invention.

FIG. 2 is a schematic view illustrating one example of a power source arrangement of an electron beam device according to the present invention.

FIG. 3 is an overhead view for describing a state of electron emission in an electron-emitting device according to the present invention.

FIG. 4A and FIG. 4B are views for describing an operation during a driving period of an electron-emitting device according to the present invention.

FIGS. 5A, 5B, 5C, 5D, 5E, 5F and 5G are views for describing a method of manufacturing the electron-emitting device according to the first example of the present invention.

FIG. 6 is a view for describing a structure of an image-forming apparatus using an electron source of the present invention.

FIG. 7 is a view for describing the vicinity of a recess portion in an electron-emitting device according to the present invention.

FIGS. 8A, 8B and 8C are schematic views of an electron-emitting device according to a second example of the present invention.

FIGS. 9A, 9B and 9C are schematic views of an electron-emitting device according to a third example of the present invention.

FIG. 10 is an overhead view of the electron-emitting device according to the third example of the present invention.

FIGS. 11A, 11B, 11C, 11D and 11E are views for describing a method for manufacturing the electron-emitting device according to the third example of the present invention.

FIGS. 12A, 12B and 12C are schematic views of an electron-emitting device according to a fourth example of the present invention.

### DESCRIPTION OF THE EMBODIMENTS

First, exemplary embodiments according to the present invention will be illustratively described in detail below with reference to the drawings. However, the dimensions, materials, shapes, relative arrangements and the like of components which are described in the embodiments do not limit the scope of this invention only to those, unless otherwise specified.

The present invention was extensively investigated so that each electron-emitting point in an electron-emitting portion and by extension the whole device stably operates in a simple structure.

First, a structure and the like of an electron-emitting device according to a first example of the present invention will be described.

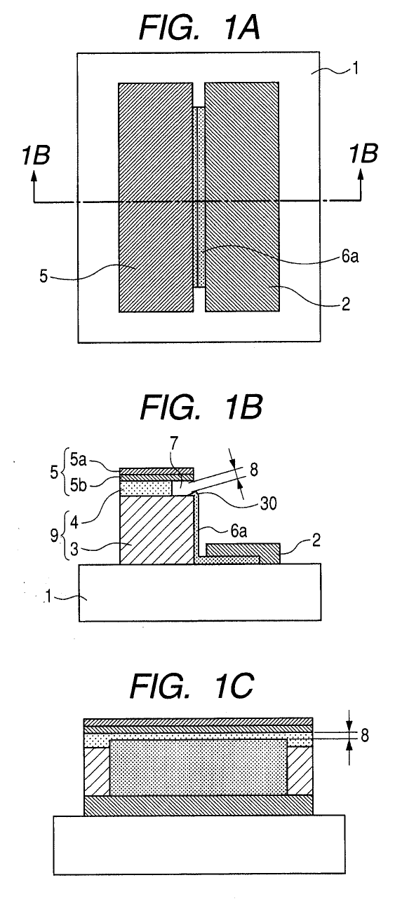

FIGS. 1A to 1C are schematic views of an electron-emitting device according to a first example of the present invention. Here, FIG. 1A is a top plan view of the device, which has been viewed from above, FIG. 1B is a sectional view taken along the line 1B-1B of FIG. 1A, and FIG. 1C is a side view of the device of FIG. 1A, which has been viewed from a direction of facing 1B from 1B.

In FIGS. 1A to 1C, a substrate 1, an electrode (device electrode) 2, a first insulating layer 3 and a second insulating layer 4 which make up an insulating member 9 are shown. A gate 5 includes two layers: electroconductive layers 5a and 5b. In addition, a cathode 6a is provided on the outer surface of the insulating member 9 (side wall face of first insulating layer 3 in present example). The cathode 6a is made from an electroconductive material and is electrically connected with the device electrode 2.

A recess portion 7 is a region in which the side wall face of the second insulating layer 4 in the outer surface of the insulating member 9 is retreated so as to be inwardly recessed compared to the tip face of the gate 5 and the side wall face of the first insulating layer 3. A gap 8 (shortest distance between cathode 6a and gate 5) is also shown in which an electric field necessary for electron emission is formed. The gap 8 is extremely narrow and is formed so as to be generally uniform in a transverse direction of the device, in other words, from left to right in FIG. 1C.

The cathode 6a has a protrusion 30 positioned so as to lie astride the outer surface of the insulating member 9 and the inner surface of the recess portion 7 which adjoins and continues to the outer surface, as will be described later in detail. The protruding part of the cathode, which is an electron-emitting portion, is positioned so as to lie astride the outer surface of the insulating layer and the inner surface of the recess portion, and accordingly may obtain a sufficient contact area with the insulating member, so that the cathode with high adhesion strength and superior thermal stability can be obtained.

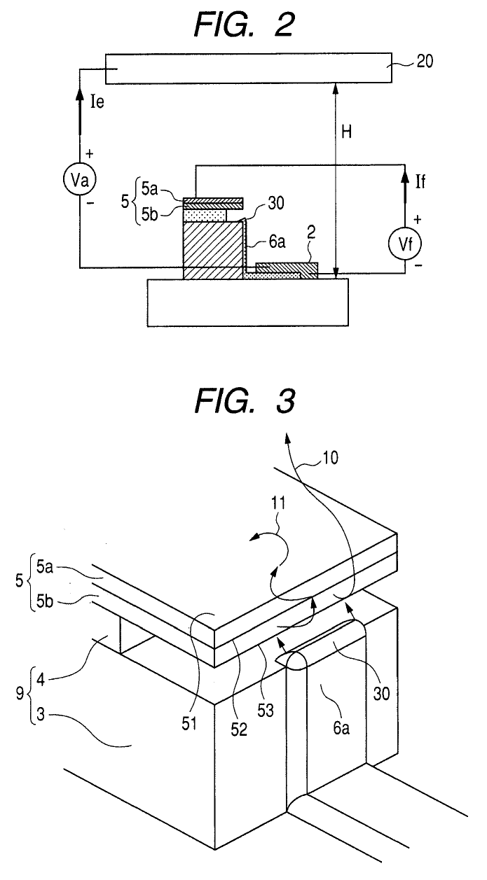

FIG. 2 illustrates one example of a power source arrangement in an electron beam device according to the present invention. A voltage Vf is applied between the gate 5 and the cathode 6a, and a device current If flows between both electrodes. An anode 20 is positioned so as to oppose to the protrusion 30 of the cathode 6a through the gate 5. A voltage Va is applied between a cathode in a low potential side and the anode 20, and an electron emission current Ie flows between the both electrodes.

Here, an efficiency η is a ratio of the number of the electrons which are emitted from the cathode 6a per unit time to the number of the electrons which reach the anode 20 per unit time, and is given by the expression of η=Ie/(If+Ie) with the use of the device current If and the electron emission current Ie.

Subsequently, a trajectory of an electron which is emitted from the device will now be described with reference to FIG. 3.

Emitted electrons first collide against a tip part of the gate 5. Some of the collided electrons are extracted by the gate 5, and the other electrons are scattered in various directions on the surface of the gate 5. The scattered electrons fly while the direction and the speed thereof are changed by the electric field in the periphery, and some electrons are extracted to the outside without colliding against the gate. The example of the trajectory is illustrated by reference numeral 10 in FIG. 3. The other electrons are attracted to the gate 5, and collide against a top face 51, a side face 52 and a back surface 53 of the gate. After that, processes are repeated which extract some of the collided electrons and scatter the other electrons. The example of the trajectory is illustrated by reference numeral 11 in FIG. 3.

In FIG. 2, the electron emission current Ie is the total number of electrons (per unit time) which have been finally extracted to the outside of the device after the above described multiple scattering, and a device current If is the total number of electrons which have been extracted by the gate 5. The gate 5 consequently generates heat due to the collision of the electrons which have been emitted from the cathode against the gate 5, and the flow of the above described If in the gate.

The heat generation of the gate 5 will now be described.

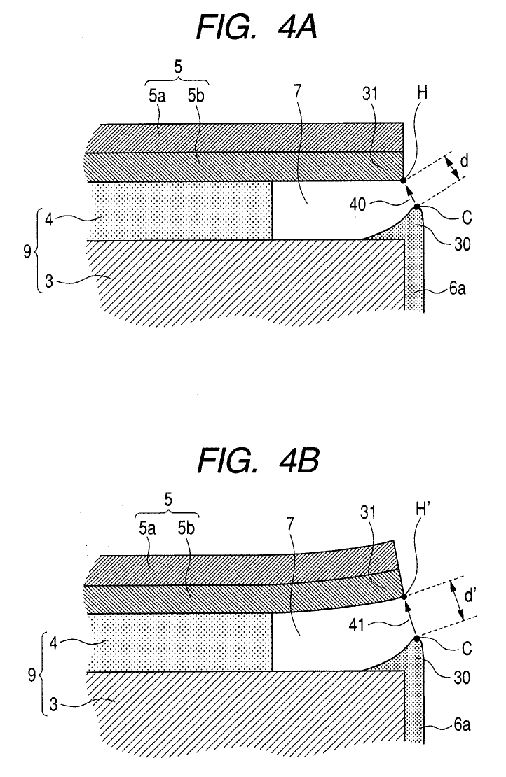

FIG. 4A is a view enlargingly illustrating the vicinity of the recess portion 7 in FIG. 1B, and illustrates a state in an early stage after the device of the present invention has been driven.

In FIG. 4A, the insulating member 9 includes the first insulating layer 3 and the second insulating layer 4. The gate 5 has a two-layer structure including an upper electroconductive layer 5a and a lower electroconductive layer 5b. The lower electroconductive layer 5b is positioned at a part opposing to the protrusion 30, and the upper electroconductive layer 5a is positioned on the lower electroconductive layer 5b. The cathode 6a, the protrusion 30 which is the top of the cathode and a tip C of the protrusion 30 are shown. A trajectory 40 of an electron which has been emitted from the point C is also shown. A tip part 31 of the lower electroconductive layer 5b, and a portion H at which the emitted electrons collide against the lower electroconductive layer 5b are shown. A distance (d) of a gap is a distance between the point C and the point H.

A part in the vicinity of the recess portion 7, at which heat is remarkably generated while the device is driven, is the protrusion 30 that is the top of the cathode 6a, and the tip part 31 of the lower electroconductive layer 5b. The protrusion 30 generates heat by Nottingham effect and Joule heat due to the emission of electrons from the point C. On the other hand, the tip part 31 of the gate is heated by the energy of electrons which have been extracted from the point H into the gate 5. The gate 5 is also heated by electrons which are extracted by the lower electroconductive layer 5b and the upper electroconductive layer 5a as a result of the multiple scattering.

If the device was appropriately structured, the device would not cause a problem in the operation even when the heat was generated due to the above described causes during a driving period. However, a more number of electrons than a supposed number can be emitted from the point C, when a distance (d) of the gap is shorter than a predetermined length due to fluctuation in manufacture, or when molecules of a remaining gas are adsorbed during operation. The excessive heat which has been generated in the vicinity of the recess portion 7 causes the deformation and melting of the gate 5, and causes the deterioration of the device characteristics or fracture in an extreme case.

In addition, when the protrusion 30 of the cathode 6a is also formed on the inner surface of the recess portion 7, as is illustrated in FIG. 4A, the force (coulombic force) which attracts the gate 5 to the cathode 6a becomes large, and the gate 5 can be deformed toward the cathode 6a. When the gate 5 is deformed toward the cathode 6a, more electrons collide against the gate 5 and the device current If (see FIG. 2) increases and thus the heat generation in the gate 5 increases resulting in that the gate 5 tends to cause the above described deformation and melting, which is a problem.

In order to prevent such a situation, the gate 5 in the present invention has a multilayer structure, and the lower electroconductive layer 5b is formed of a material having a larger thermal expansion coefficient than that of the upper electroconductive layer 5a.

FIG. 4B illustrates a state of a device according to the present invention, which operates while inhibiting the generation of excessive heat. In FIG. 4B, a trajectory 41 of an electron which has been emitted from the point C, and a portion H′ at which the emitted electrons collide against the lower electroconductive layer 5b are shown. In addition, a distance (d′) of a gap is a distance between the point C and the point H′.

When heat generates in the vicinity of the recess portion 7, the temperature of the gate 5 also rises. Then, the gate 5 is warped so that the tip part 31 of the gate moves away from the protrusion 30, being caused by a difference between a thermal expansion coefficient of the lower electroconductive layer 5b and a thermal expansion coefficient of the upper electroconductive layer 5a, and the distance (d′) of the gap increases. As a result, an electric field in the point C decreases and an emission current decreases, so that a heat to be generated in the vicinity of the recess portion 7 also decreases. Such a distance (d′) of the gap is automatically adjusted according to a degree of the heat to be generated in the device, so that the device stably operates for a long period of time. In this way, the structure according to the present invention shows the following advantages.

First, a cathode according to the present invention is positioned so as to lie astride the outer surface of an insulating member and the inner surface of a recess portion, and has a protrusion that is a part which opposes to an anode and emits an electron. The protrusion is provided so as to lie astride two surfaces including the outer surface of the insulating member and the inner surface of the recess portion, so that the cathode can have a wide surface for adhering to the insulating member, superior mechanical stability, and a wider heat radiation surface. For this reason, the device can easily obtain stable characteristics of electron emission, and shows superior heat characteristics.

In addition, the gate according to the present invention has a layered structure including at least two electroconductive layers which have different thermal expansion coefficients from each other, so that the gate is warped due to a bimetal effect, when having been excessively overheated. Furthermore, the thermal expansion coefficient of the electroconductive layer positioned in a part opposing to the protrusion is larger than those of the other electroconductive layers, so that the gate is warped toward a direction moving away from the above described protrusion. As a result, the electric field in between the cathode and the anode is weakened, the amount of the emitted electrons is suppressed, the heating value is lowered, and the deterioration of the device and the fracture of the device due to overheat can be prevented.

In addition, when the temperature of the gate is lowered, the warp of the gate is recovered. When the temperature of the gate rises again, the gate is warped, and the temperature is lowered. The above steps shall be automatically repeated.

Accordingly, the present invention can provide a preferable electron-emitting device which maintains stable device characteristics even when having been driven for a long period of time.

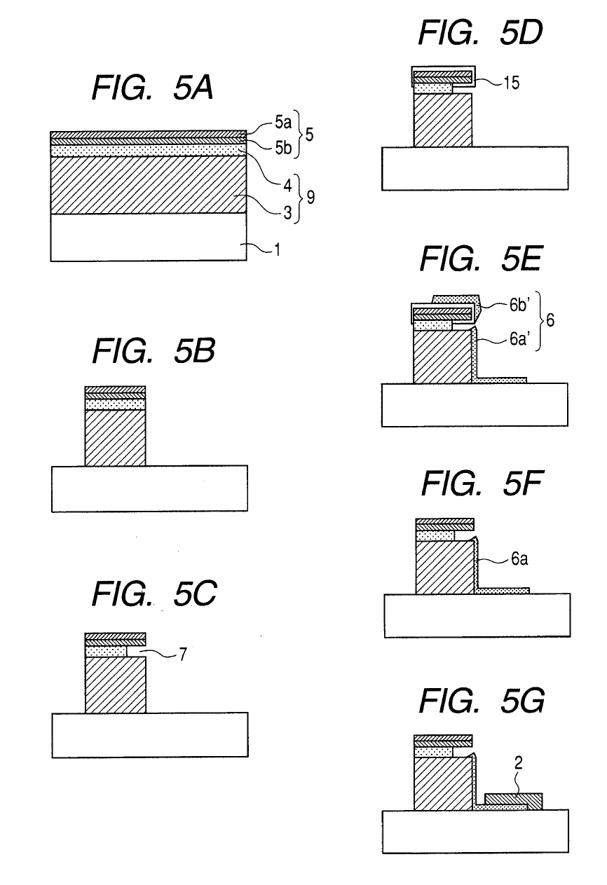

In the above description, the representative structure and operation of an electron-emitting device according to the first example of the present invention have been described. Next, a manufacturing method therefor will be described with reference to FIG. 5.

FIG. 5A to FIG. 5G are schematic views sequentially illustrating a process of manufacturing the electron-emitting device according to the first example of the present invention.

The substrate 1 is a substrate for mechanically supporting a device, and is a substrate made from a glass in which an amount of impurities such as Na is reduced, quartz glass, soda lime glass or silicon. The substrate 1 can have not only a high mechanical strength but also resistances to dry etching, wet etching, an alkaline solution and an acid solution such as a liquid developer as its necessary functions. When being employed in an integral product such as a display panel, the substrate desirably has a smaller thermal expansion coefficient than a film-forming material or other stacked members. The substrate 1 is desirably made from such a material as to make an alkali element or the like less diffuse out from the inner part of the glass when heat-treated.

First, the first insulating layer 3 and the second insulating layer 4 which make up the insulating member 9, and the gate 5 are stacked on the substrate 1, as is illustrated in FIG. 5A.

The first insulating layer 3 is an insulative film made from a material having excellent processability; is made from SiN (SiₓN_{y}) or Sio₂, for instance; and is formed with a general vacuum film-forming method such as a sputtering method, a CVD method and a vacuum vapor-deposition method. The thickness is set in a range of several nanometers to several tens of micrometers, and can be selected from a range of several tens of nanometers to several hundreds of nanometers.

Similarly, the second insulating layer 4 is also an insulative film made from a material having excellent processability; is made from SiN (SiₓN_{y}), SiO₂ or the like; and is formed with a general vacuum film-forming method. The thickness is set in a range of several nanometers to several hundreds of nanometers, and can be selected from a range of several nanometers to several tens of nanometers.

An amount to be etched of the first insulating layer 3 is set so as to be different from that of the second insulating layer 4, because the recess portion 7 needs to be formed after the first and second insulating layers 3 and 4 have been stacked. The selection ratio between the first insulating layer 3 and the second insulating layer 4 is desirably set at 10 or more, and is more desirably set at 50 or more. For instance, SiN (SiₓN_{y}) can be used for the first insulating layer 3, and the second insulating layer 4 can include an insulative material such as SiO₂, a PSG film having a high phosphorus concentration, a BSG film having a high boron concentration or the like.

The gate 5 includes two layers, the upper electroconductive layer 5a and the lower electroconductive layer 5b, and is formed with a general vacuum film-forming technology such as a vapor deposition method and a sputtering method. Materials which make up the upper electroconductive layer 5a and the lower electroconductive layer 5b are selected so that the electroconductive layer 5b has a larger thermal expansion coefficient than that of the electroconductive layer 5a. In addition, both of the materials desirably have high thermal conductivity and a high melting point. For information, the gate 5 of this example has a layered structure including two layers, the upper electroconductive layer 5a and the lower electroconductive layer 5b. However, the layered structure may comprise at least two layers, and can form the whole structure from three layers or more by making the upper electroconductive layer 5a be multiple layers.

The material which makes up the electroconductive layer 5b positioned so as to be closest to the protrusion 30 side is selected from such materials as to have a larger thermal expansion coefficient than thermal expansion coefficients of other materials which make up the electroconductive layer 5a and the like. The thermal expansion coefficient of the material which makes up the electroconductive layer 5b can be twice or more than thermal expansion coefficients of other materials which make up the electroconductive layer 5a and the like.

The electroconductive materials to be used for making up the electroconductive layers 5a and 5b may include metals such as Be, Mg, Ti, Zr, Hf, V, Nb, Ta, Mo, W, Al, Cu, Ni, Cr, Au, Pt and Pd, and alloy materials thereof. The electroconductive materials to be used may also include carbides such as TiC, ZrC, HfC, TaC, SiC and WC. The electroconductive materials to be used may also include borides such as HfB₂, ZrB₂, CeB₆, YB₄ and GdB₄, nitrides such as TiN, ZrN, HfN and TaN and semiconductors such as Si and Ge. The electroconductive materials to be used may further include amorphous carbon, graphite, diamond-like carbon, carbon having diamond dispersed therein, and carbon compounds, as well.

The thickness of the whole gate 5 is set in a range of several nanometers to several hundreds of nanometers, and can be selected from a range of several tens of nanometers to several hundreds of nanometers. The thicknesses of the upper electroconductive layer 5a and the lower electroconductive layer 5b are appropriately determined in consideration of the quantity of the warping of the gate 5 when the device operates.

Subsequently, a resist pattern is formed on the gate 5 with a photolithographic technology, and then the gate 5, the second insulating layer 4 and the first insulating layer 3 are sequentially processed with an etching technique, as is illustrated in FIG. 5B.

A method to be generally employed for such an etching process is an RIE (Reactive Ion Etching) process. The etching process can precisely etch a material by irradiating the material with a plasma that has been formed through the conversion of an etching gas. The etching gas to be selected at this time is a fluorine-based gas such as CF₄, CHF₃ and SF₆, when an objective member to be processed forms a fluoride. When the objective member forms a chloride as Si and Al do, a chlorine-based gas such as Cl₂ and BCl₃ is selected. In order to increase an etching speed, a gas of hydrogen, oxygen, argon and the like is added whenever necessary. In order to impart a selection ratio to the above layers with respect to a resist, faces to be etched are desirably reliably smooth.

Furthermore, the second insulating layer 4 is recessed by using an etching technique to form the recess portion 7 therein, as is illustrated in FIG. 5C.

For instance, when the second insulating layer 4 is a material formed from SiO₂, the second insulating layer 4 can be etched with the use of a mixture solution of ammonium fluoride and hydrofluoric acid, which is referred to as a buffered hydrofluoric acid (BHF), and when the second insulating layer 4 is a material formed from SiₓN_{y}, the second insulating layer 4 can be etched with the use of a phosphoric-acid-based hot etching solution.

The depth of the recess portion 7 relates to the magnitude of a leakage current flowing after a device has been formed. Generally, the more deeply the recess portion 7 is formed, the smaller the magnitude of the leakage current is. However, when the recess portion 7 is excessively deep, problems such as a deformation of the gate 5 occur, so that the recess portion 7 is formed so as to be approximately 30 nm to 200 nm deep.

Subsequently, a release layer 15 is formed on the outer surface of the gate 5, as is illustrated in FIG. 5D.

The release layer 15 is formed for the purpose of stripping a cathode material 6 which will deposit on the gate 5 in the next step, from the gate 5. The release layer 15 is formed, for instance, with a method of oxidizing the gate 5 to form an oxide film thereon, depositing a release metal with an electrolytic plating technique, or the like.

Afterward, the cathode material 6 is deposited on the gate 5, the outer surface (side wall face) of the insulating member 9 (first insulating layer 3), the inner surface of the recess portion (top face of first insulating layer 3) and the surface of the substrate 1, as is illustrated in FIG. 5E. Among the cathode material 6, a cathode material 6a′ makes up the cathode 6a, which has been deposited on the side wall face and the top face of the first insulating layer 3 and on the surface of the substrate 1. A cathode material 6b′ which has been deposited on the gate 5 is removed afterward.

The cathode material 6 is deposited with a general vacuum film-forming technology such as a vapor deposition method and a sputtering method. As was described above, in the present invention, the cathode can be formed so that the shape of the cathode 6a in a gate 5 side can be optimum for efficiently extracting electrons, by controlling an angle and a film-forming period of time in vapor deposition, a temperature during film formation and a vacuum degree during film formation.

The cathode material 6 may be a material which has electroconductivity and emits an electric field, and generally can be a material which has a high melting point of 2,000° C. or higher, has a work function of 5 eV or smaller, and hardly forms a chemical reaction layer thereon such as an oxide or can make the reaction layer easily removed therefrom. Such materials include, for instance: metals such as Hf, V, Nb, Ta, Mo, W, Au, Pt and Pd or alloy materials thereof; carbides such as TiC, ZrC, HfC, TaC, SiC and WC; and borides such as HfB₂, ZrB₂, CeB₆, YB₄ and GdB₄. The materials also include: nitrides such as TiN, ZrN, HfN and TaN; and amorphous carbon, graphite, diamond-like carbon, carbon having diamond dispersed therein, and carbon compounds.

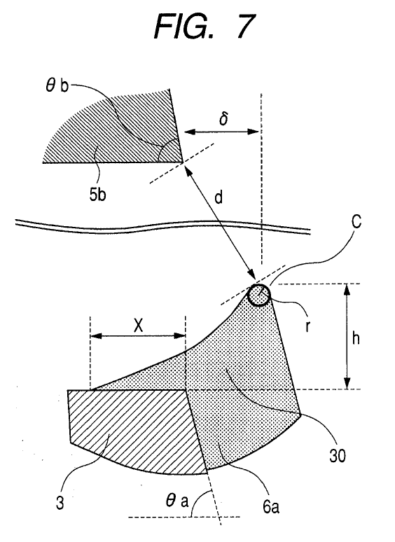

Subsequently, the cathode material 6b′ on the gate 5 is removed by removing the release layer 15 with an etching technique, as is illustrated in FIG. 5F. Finally, the device electrode 2 is formed which is electrically connected to the cathode 6a that has been formed by dividing the cathode material 6a′ deposited as a continuous film into a strip shape as needed, as is illustrated in FIG. 7G.

The device electrode 2 has electroconductivity, and is formed with a general film-forming technology such as a vapor deposition method and a sputtering method and with a photolithographic technology. The materials to be used may include: metals such as Be, Mg, Ti, Zr, Hf, V, Nb, Ta, Mo, W, Al, Cu, Ni, Cr, Au, Pt and Pd, or alloy materials thereof; and carbides such as TiC, ZrC, HfC, TaC, SiC and WC. The materials to be used may also include: borides such as HfB₂, ZrB₂, CeB₆, YB₄ and GdB₄; nitrides such as TiN, ZrN and HfN; and semiconductors such as Si and Ge. The materials to be used may further include amorphous carbon, graphite, diamond-like carbon, carbon having diamond dispersed therein, and carbon compounds, as well. In addition, the thickness of the device electrode 2 is set in a range of several tens of nanometers to several millimeters, and can be selected from a range of several tens of nanometers to several micrometers.

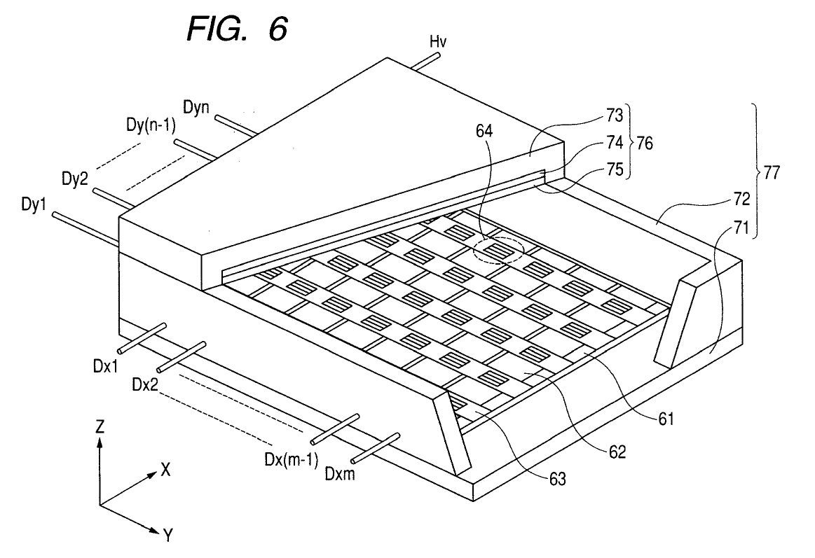

In the above description, a representative method of manufacturing the electron-emitting device according to the first example of the present invention was described. Subsequently, an example of the applicable application will be described with reference to FIG. 6.

An electron source and an image-forming apparatus can be formed by arranging a plurality of electron-emitting devices according to the present invention on a substrate 61. An example of the arrangement includes a so-called simple matrix arrangement. The arrangement is formed specifically by arranging a plurality of electron-emitting devices into a matrix form of an X-direction and a Y-direction, and connecting one electrode of the device belonging to the row to common wires in the X-direction, and the other electrode of the device belonging to the column to common wires in the Y-direction, respectively. The state is illustrated in FIG. 6.

In FIG. 6, the electron source substrate 61, wires in an X-direction 62 and wires in a Y-direction 63 are shown. An electron-emitting device 64 according to the embodiment of the present invention is also shown.

The wires in the X-direction 62 are formed of m lines of wires Dx1 and Dx2 continued to Dxm, and can include an electroconductive metal or the like, which has been formed by using a vacuum vapor-deposition method, a printing method, a sputtering method and the like. The material, film-thickness and width of the wires are appropriately designed. The wires in the Y-direction 63 are formed of n lines of wires Dy1 and Dy2 continued to Dyn, and are formed in a similar way to the wires in the X-direction 62. Here, m and n are both positive integer numbers. In addition, each wire is provided with an external terminal for being drawn for the case of being driven from the outside.

An unshown interlayer insulating layer is provided in between m lines of the wires in the X-direction 62 and n lines of the wires in the Y-direction 63, and electrically separates the both lines from each other. The unshown interlayer insulating layer includes SiO₂ or the like, which has been formed with the use of a vacuum vapor-deposition method, a printing method, a sputtering method or the like. The unshown interlayer insulating layer is formed, for instance, on the whole surface or one part of the surface of the electron source substrate 61 having the wires in the X-direction 62 formed thereon to form a desired shape; and the film-thickness, the material and the manufacturing method are appropriately set so that the interlayer insulating layer can resist particularly a potential difference in the intersections of the wires in the X-direction 62 and the wires in the Y-direction 63.

The electrodes (device electrode 2 and gate 5 described in FIGS. 1A to 1C) which make up the electron-emitting device 64 are electrically connected to the wires in the X-direction 62 and the wires in the Y-direction 63, respectively.

A material making up the wires 62 and the wires 63 may be made from a partially equal constituent element or a totally equal constituent element, or may be made from different constituent elements respectively. The materials are appropriately selected from the above described materials for the device electrode, for instance.

An unshown scan-signal-applying unit is connected to the wires in the X-direction 62. The image-forming apparatus selects a row of electron-emitting devices 64 which are arrayed in the X-direction, by a scan signal. On the other hand, an unshown modulation-signal-generating unit is connected to the wires in the Y-direction 63. The image-forming apparatus modulates each column of the electron-emitting devices 64 which have been arrayed in the Y-direction according to an input signal of a modulation signal.

A driving voltage to be applied to each of the electron-emitting devices is supplied in a form of a differential voltage between the scan signal and the modulation signal to be applied to the device. In other words, the image-forming apparatus drives each device by selecting the X-direction and the Y-direction simultaneously.

In addition, a rear plate 71 fixes the electron source substrate 61 thereon, and a face plate 76 has a fluorescent film 74 that is a phosphor functioning as a light-emitting member, a metal back 75 and the like, which are formed on the inner surface of a transparent glass substrate 73.

In addition, a supporting frame 72 is connected to the rear plate 71 and the face plate 76 through glass frit or the like. An envelope 77 (display panel) is structured so as to seal the supporting frame 72, the rear plate 71 and the face plate 76, by baking the frit glass in the atmosphere or nitrogen gas in a temperature range of 400 to 500° C. for 10 minutes or longer, for instance. The rear plate 71 is provided mainly for the purpose of reinforcing the strength of the substrate 61, and accordingly can be eliminated when the substrate 61 itself has a sufficient strength. On the other hand, an unshown support member referred to as a spacer is occasionally installed as well in between the face plate 76 and the rear plate 71 so that the envelope 77 (display panel) can be thereby structured to have a sufficient strength against atmospheric pressure.

A corresponding phosphor (not shown) is arranged at an appropriate position in the fluorescent film 74 of the face plate 76, in consideration of a device array on the rear plate 71 and a trajectory of an electron to be emitted. As a matter of course, the face plate 76 itself is appropriately aligned, and then is fixed with the rear plate 71.

When the display panel 77 is used for displaying an image such as a television image thereon, unshown driving circuits which drive an electron source from the outside are connected to a terminal group Dx1 to Dxm, a terminal group Dy1 to Dyn and a high-voltage terminal Hv. The driving circuit generates an image signal based on a desired display system such as an NTSC system. Among the image signals, a scan signal is applied to the terminal group Dx1 to Dxm, and a modulation signal is applied to the terminal group Dy1 to Dyn, respectively. An accelerating voltage is applied to the high-voltage terminal Hv. This is for the purpose of imparting sufficient energy for exciting the phosphor to an electron to be emitted from each device.

The structure of the image-forming apparatus described here is one example, and various modifications can be created based on the technological concept of the present invention. For instance, the display system of the image may employ a system corresponding to a high-grade TV including a MUSE system other than a PAL system and a SECAM system.

Furthermore, the image-forming apparatus according to the embodiment of the present invention can also be used for an image-forming apparatus or the like to be used as a photo printer which is structured by using a photosensitive drum or the like, in addition to a display apparatus for a television broadcast and a display apparatus for a video teleconference system, a computer and the like.

For information, the gate 5 means, in a broad sense, all of electrodes in a high-potential side, which are electrically connected to the gate 5. Accordingly, a gate auxiliary layer 6b in Exemplary embodiments 3 to 5 which will be described later also makes up one part of the gate 5. Similarly, the cathode 6a means, in a broad sense, all of electrodes in a low potential side, which include the cathode 6a and the device electrode 2 and are electrically connected to the cathode 6a and the device electrode 2.

### EXEMPLARY EMBODIMENT

The present invention will now be described in detail below with reference to specific exemplary embodiments.

### Exemplary Embodiment 1

The electron-emitting device according to the present exemplary embodiment was described with reference to FIGS. 1A to 1C, and a method for manufacturing the electron-emitting device according to the present exemplary embodiment will now be described with reference to FIGS. 5A to 5G.

The substrate 1 is for the purpose of mechanically supporting the device, and in the present exemplary embodiment, PD200 which is a low-sodium glass that has been developed for a plasma display was used.

First, the first insulating layer 3 and the second insulating layer 4 which made up the insulating member 9, and the gate 5 were stacked on the substrate 1, as is illustrated in FIG. 5A.

The first insulating layer 3 is a film made from an insulative material having excellent processability. The layer of SiN (SiₓN_{y}) was formed with a sputtering method, and the thickness was approximately 500 nm.

The second insulating layer 4 is a film made from an insulative material having similarly excellent processability. The layer of SiO₂ was formed with a sputtering method, and the thickness was approximately 30 nm.

Subsequently, the gate 5 was formed. A film of Pt (thermal expansion coefficient of 8.8 E⁻⁶/K) having the thickness of 30 nm was formed for the lower electroconductive layer 5b, and a film of TaN (thermal expansion coefficient of 3.6E⁻⁶/K) having the thickness of 30 nm was formed for the upper electroconductive layer 5a, with the sputtering method, respectively.

Subsequently, a resist pattern was formed on the gate 5 with a photolithographic technology, and then the gate 5, the second insulating layer 4 and the first insulating layer 3 were sequentially processed with a dry etching technique, as is illustrated in FIG. 5B.

In the present exemplary embodiment, a material which forms a fluoride was selected for the first and second insulating layers 3 and 4 and the gate 5, so that a CF₄-based processing gas was used. As a result of having subjected the layers to an RIE process with the use of the gas, the side wall faces obtained after having been etched of the first insulating layer 3, the second insulating layer 4 and the gate 5 showed angles of approximately 80 degrees with respect to the surface of the substrate 1.

After the resist was stripped off, the recess portion 7 was formed in the second insulating layer 4 into a depth of approximately 70 nm, by recessing (retreating) the side end face of the second insulating layer 4 through an etching technique with the use of BHF, as is illustrated in FIG. 5C.

Subsequently, a release layer 15 was formed on the gate 5, as is illustrated in FIG. 5D. The release layer 15 was formed by electrodepositing Ni on the gate 5 of TaN with an electrolytic plating technique.

Then, Molybdenum (Mo) of the cathode material 6 was formed on the device, as is illustrated in FIG. 5E. The reference character 6b′ denotes the cathode material 6 which has deposited on the gate 5, and the reference character 6a′ denotes the cathode material 6 which has deposited on regions from the outer face of the insulating layer 3 to the inner surface of the recess portion, and from the outer surface of the insulating layer 3 to the surface of the substrate 1.

In the present exemplary embodiment, an EB vapor-deposition method was employed as a film-forming method. In addition, in the present forming method, the substrate 1 was set in the apparatus at the angle of 60 degrees with respect to a horizontal plane. Thereby, Mo was incident on the upper part of the gate 5 at approximately 60 degrees, and was incident on a tilted side wall face of the first insulating layer 3 which had been subjected to an RIE processing, at approximately 40 degrees. The vapor deposition operation was carried out at a fixed deposition speed of approximately 12 nm/min for approximately 2.5 minutes. The film of Mo was formed so as to have the thickness of 30 nm on the outer surface of the first insulating layer 3 by precisely controlling the vapor deposition period of time.

After the Mo film was formed, the cathode material 6b′ was stripped from the gate 5, by removing the release layer 15 of Ni which had been deposited on the gate 5, with the use of an etchant containing iodine and potassium iodide, as is illustrated in FIG. 5F.

After the above described stripping operation, a resist pattern having the width of 100 μm was formed on the cathode material 6a′ with a photolithographic technology. Subsequently, the cathode 6a was formed by processing the cathode material 6a′ with a dry etching technique and removing an unnecessary resist. A processing gas used at this time was a CF₄-based gas so as to suit molybdenum of the cathode material 6.

Finally, the device electrode 2 was formed, as is illustrated in FIG. 5G. The material was copper (Cu), and the electrode was formed with a sputtering method. The thickness of the electrode was approximately 500 nm.

After the device was formed through the above described method, the characteristics of the present structure were evaluated by using the power source arrangement illustrated in FIG. 2.

In FIG. 2, a driving voltage Vf is applied between the gate 5 which becomes a high potential side and the cathode 6a which becomes a low potential side, a device current If flows at this time, a voltage Va is applied between the cathode 6a and the device electrode 2 which were the low potential side and an anode 20, and an electron emission current Ie flows in between them.

As a result of having evaluated characteristics of the present structure, a device was obtained of which the driving voltage Vf was 26 V, the average of the electron emission current Ie was 1.5 μA and the average of the efficiency η was 17%. In the device according to the present invention, the distance (d) of a gap (see FIG. 4) is automatically adjusted according to a degree of heat to be generated, so that the device stably operated for a long period of time compared to a conventional device. In addition, the device makes the protruding portion of the cathode to be an electron-emitting portion embedded in a recess portion (recess) and brings the protruding portion into contact with the inner surface of the recess portion, which thereby enhances thermal and mechanical stability. As a result, an adequate electron-emitting device was obtained which showed a small fluctuation amount (reduced amount) of Ie and stably operated even when having been continuously driven.

In addition, as a result of having observed the cross section of the cathode portion in the device with a TEM, the cathode portion showed the shape as illustrated in FIG. 7. As a result of having extracted values of each parameter from the TEM image of the cross section, the values were as follows: θa=75°, θb=80°, X=35 nm, h=29 nm, δ=11 nm and d=9 nm.

### Exemplary Embodiment 2

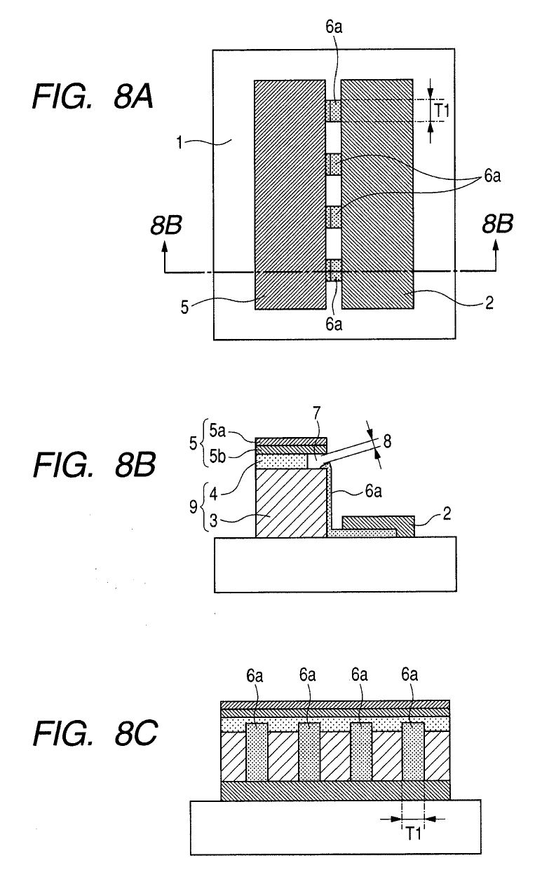

FIGS. 8A to 8C is a schematic view of an electron-emitting device according to a second example of the present invention. FIG. 8A is a top plan view, FIG. 8B is a sectional view taken along the line 8B-8B in FIG. 8A, and FIG. 8C is a side view of a device of FIG. 8A, which has been viewed from a direction of facing 8B from 8B. The electron-emitting device according to the present exemplary embodiment will now be described with reference to FIGS. 8A to 8B.

In FIGS. 8A to 8C, the substrate 1, the electrode (device electrode) 2, and the first insulating layer 3 and the second insulating layer 4 which make up the insulating member 9 are shown. The gate 5 includes two layers' the upper electroconductive layer 5a and the lower electroconductive layer 5b. In addition, a plurality of cathodes 6a each having a strip shape are formed on the outer surface (side wall face) of the insulating member 9 of the first insulating layer 3. The cathode 6a is formed from an electroconductive material, and is electrically connected to the device electrode 2. The recess portion 7 is a region in which the side wall face of the second insulating layer 4 in the insulating member 9 is retreated so as to be recessed toward the inside compared to the tip face of the gate 5 and the side wall face of the first insulating layer 3. The gap 8 is also shown in which an electric field necessary for an electron emission is formed. The gap 8 is extremely narrow and is formed so as to be generally uniform in a transverse direction of the device, in other words, in a direction from left to right in FIG. 8C.

The basic production method is similar to that in Exemplary embodiment 1, so that the difference between the methods only will now be described below with reference to FIG. 5.

In the present exemplary embodiment, molybdenum (Mo) of the cathode material 6 was deposited on the release layer and the insulating member with an EB vapor-deposition method. The tilting angle of the substrate 1 during film formation was set at 80 degrees. Thereby, Mo was incident on the upper part of the gate 5 at approximately 80 degrees, and was incident on a tilted side wall face of the first insulating layer 3 which had been subjected to an RIE processing, at approximately 20 degrees. The vapor deposition operation was carried out at a fixed deposition speed of approximately 10 nm/min for approximately 2 minutes. The film of Mo was formed so as to have the thickness of 20 nm on the tilted side wall face of the first insulating layer 3 (outer surface of insulating member 9) by precisely controlling the vapor deposition period of time.

After the Mo film was formed, the cathode material 6b′ was stripped from the gate 5, by removing the release layer 15 of Ni which had been deposited on the gate 5, with the use of an etchant containing iodine and potassium iodide.

After the above described stripping operation, a resist pattern having the line width and space width of 3 μm was formed on the cathode material 6a′ which has been deposited on the side wall surface of the first insulating layer 3 with a photolithographic technology.

Subsequently, a plurality of cathodes 6a were formed by dividing and processing the cathode material 6a′ with a dry etching technique and removing an unnecessary resist. A processing gas used at this time was a CF₄-based gas so as to suit molybdenum of the cathode material 6.

As a result of having analyzed the cross section with a TEM, the average value of the gap 8 in FIG. 8B (shortest distance between cathode 6a and gate 5) was 8.5 nm.

After the device having the plurality of the cathodes 6a was formed through the above described method, the characteristics of the electron source were evaluated by using the power source arrangement illustrated in FIG. 2.

As a result of having evaluated characteristics of the present structure, a device was obtained of which the driving voltage Vf was 26 V, the average of the electron emission current Ie was 6.2 μA and the average of the efficiency η was 17%. Considered from this characteristics, it is assumed that the electron emission current increased by just the number of the strip, as a result of having divided the cathode 6a into a plurality of strip shapes.

A device having the strips with the line width and space width of 0.5 μm in the number increased to 100 times more than the previous device was prepared in a similar manufacturing process. Then, the device showed approximately 100 times more amount of emitted electrons than the previous device.

The electron-emitting device thus having the plurality of the strip-shaped cathodes 6a shows the same advantage as in Exemplary embodiment 1, and simultaneously can decrease the variation of the electron emission characteristics among electron-emitting devices.

### Exemplary Embodiment 3

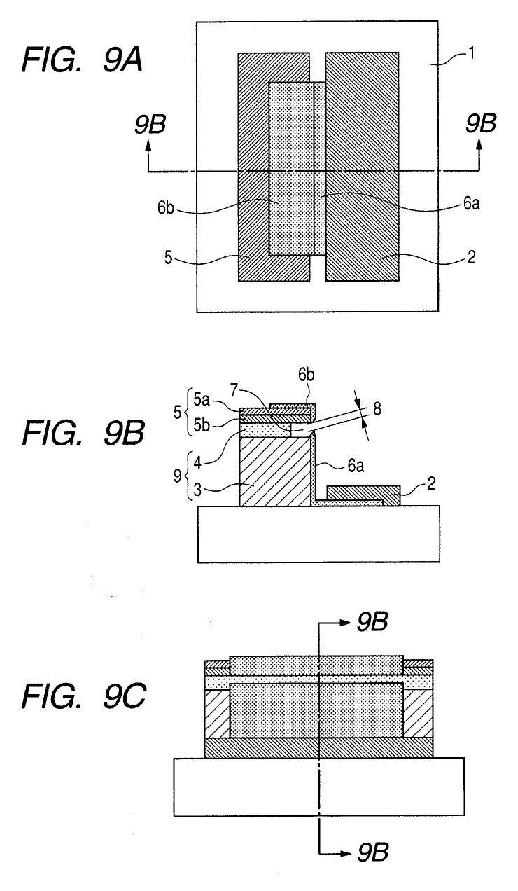

FIGS. 9A to 9C are schematic views of an electron-emitting device according to a third example of the present invention. FIG. 9A is a top plan view, FIG. 9B is a sectional view taken along the line 9B-9B in FIG. 9A, and FIG. 9C is a side view of a device of FIG. 9A, which has been viewed from a direction of facing 9B from 9B. The electron-emitting device according to the present exemplary embodiment will now be described with reference to FIGS. 9A to 9C.

In FIGS. 9A to 9C, the substrate 1, the electrode (device electrode) 2, and the first insulating layer 3 and the second insulating layer 4 which make up the insulating member 9 are shown. The gate 5 includes two layers' the upper electroconductive layer 5a and the lower electroconductive layer 5b. In addition, the cathode 6a is formed on the outer surface (side wall face) of the first insulating layer 3 and the inner surface (top face of first insulating layer 3) of the recess portion. The cathode 6a is formed from an electroconductive material, and is electrically connected to the device electrode 2.

On the other hand, a gate auxiliary layer 6b makes up one part of the gate 5, and is formed on a region from the top face of the gate 5 to the tip face (side wall face) of the gate 5. The gate auxiliary layer 6b is formed of the same electroconductive material as that of the cathode 6a in a low potential side, and is electrically connected to the gate 5.

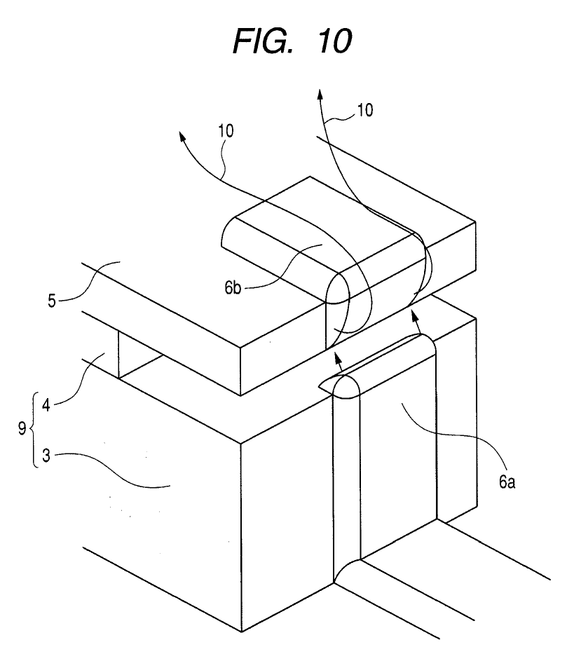

The recess portion 7 is a region in which the side wall face of the second insulating layer 4 on the outer surface (side wall face) of the insulating member 9 is retreated so as to be recessed toward the inner part compared to the tip face of the gate 5 and the side wall face of the first insulating layer 3. The gap 8 is also shown in which an electric field necessary for an electron emission is formed. The gap 8 is extremely narrow and is formed so as to be generally uniform in a transverse direction of the device, in other words, in a direction from left to right in FIG. 9C. The perspective view of the entire device is illustrated in FIG. 10.

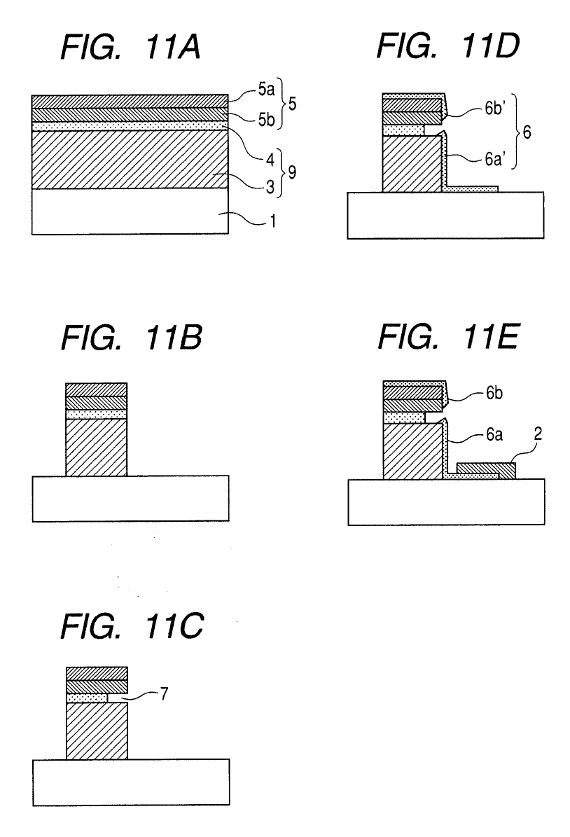

Subsequently, one example of a method for manufacturing an electron-emitting device according to an embodiment of the present invention will now be described. FIGS. 11A to 11E are schematic views sequentially illustrating a process of manufacturing the electron-emitting device according to the embodiment of the present invention.

The substrate 1 is for the purpose of mechanically supporting the device, and in the present exemplary embodiment, PD200 which is a low-sodium glass that has been developed for a plasma display was used.

First, the first insulating layer 3 and the second insulating layer 4 which made up the insulating member 9, and the gate 5 were stacked on the substrate 1, as is illustrated in FIG. 11A.

The first insulating layer 3 is a film made from an insulative material having excellent processability. The layer of SiN (SiₓN_{y}) was formed with a sputtering method, and the thickness was approximately 500 nm.

The second insulating layer 4 is a film made from an insulative material having similarly excellent processability. The layer was formed from SiO₂ with a sputtering method, and the thickness was approximately 40 nm.

The gate 5 had a two-layer structure. A film of Pt having the thickness of 30 nm was formed for the lower electroconductive layer 5b, and a film of TaN having the thickness of 30 nm was formed for the upper electroconductive layer 5a, with the sputtering method, respectively.

After the layers were stacked, a resist pattern was formed on the gate 5 with a photolithographic technology, as is illustrated in FIG. 11B. Then, the gate 5, the second insulating layer 4 and the first insulating layer 3 were sequentially processed with a dry etching technique.

In the present exemplary embodiment, a material which forms a fluoride was selected for the first and second insulating layers 3 and 4 and the gate 5, so that a CF₄-based processing gas was used. As a result of having subjected the layers to an RIE process with the use of the gas, the side wall faces obtained after having been etched of the first insulating layer 3, the second insulating layer 4 and the gate 5 showed angles of approximately 80 degrees with respect to the surface of the substrate 1.

After the resist was stripped off, the recess portion 7 was formed in the second insulating layer 4 into a depth of approximately 100 nm, by recessing (retreating) the side end face of the second insulating layer 4 through an etching technique with the use of BHF, as is illustrated in FIG. 11C.

In the present exemplary embodiment, molybdenum (Mo) of the cathode material 6 was deposited on the gate 5 as well, as is expressed by 6b′ in FIG. 11D. An EB vapor-deposition method was used as a film-forming method.

In the present forming method, the angle of the substrate 1 was set at 60 degrees. Thereby, Mo was incident on the upper part of the gate 5 at 60 degrees, and was incident on a tilted side wall face of the first insulating layer 3 which had been subjected to an RIE processing, at 40 degrees. The vapor deposition operation was carried out at a fixed deposition speed of approximately 10 nm/min for approximately 4 minutes. At this time, the film of Mo was formed so as to have the thickness of 40 nm on the side wall face of the first insulating layer 3 (outer surface of insulating member 9) by precisely controlling the vapor deposition period of time. For information, the thermal expansion coefficient of molybdenum is 5.1 E⁻⁶/K.

Subsequently, a resist pattern with the width of 600 μm was formed on the cathode material 6a′ which lies astride the side wall face and the top face (inner surface of recess portion) of the first insulating layer 3 and astride the side face of the insulating layer 3 and the substrate 1, and on the cathode material 6b′ of the gate 5, with the use of a photolithographic technology. Subsequently, the cathode 6a in a low potential side and the gate auxiliary layer 6b which makes up one part of the gate 5 in a high potential side were formed, by processing both films of the cathode materials 6a′ and 6b′ with a dry etching technique and removing an unnecessary resist. A processing gas used at this time was a CF₄-based gas so as to suit molybdenum of the cathode material 6.

As a result of having analyzed the cross section with a TEM, the gap 8 in FIG. 9B was 15 nm.

Subsequently, the device electrode 2 was formed, as is illustrated in FIG. 1E. The material was copper (Cu), and a sputtering method was used for film formation. The thickness was approximately 500 nm.

After the electron-emitting device having the gate auxiliary layer 6b had been formed through the above described method, the characteristics of the present electron source were evaluated by using the power source arrangement illustrated in FIG. 2.

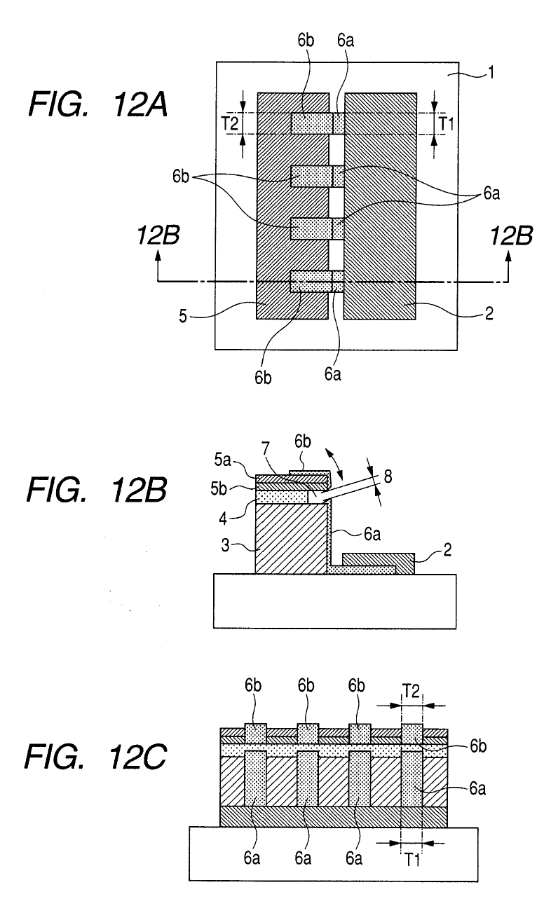

As a result of having evaluated characteristics of the present structure, a device was obtained of which the driving voltage Vf was 35 V, the average of the electron emission current Ie was 1.5 μA and the average of the efficiency η was 14%. An electron-emitting device with high efficiency was obtained by thus having the gate auxiliary layer 6b with the same width as that of the cathode 6a (length in same direction as that of T2 in FIG. 12 which will be described later).

### Exemplary Embodiment 4

FIGS. 12A to 12C are schematic views of an electron-emitting device according to a fourth example of the present invention. FIG. 12A is a top plan view, FIG. 12B is a sectional view taken along the line 12B-12B in FIG. 12A, and FIG. 12C is a side view of a device of FIG. 12A, which has been viewed from a direction of facing 12B from 12B. The electron-emitting device according to the present exemplary embodiment will now be described with reference to FIGS. 12A to 12C.

In FIGS. 12A to 12C, the substrate 1, the electrode (device electrode) 2, the first insulating layer 3 and the second insulating layer 4 which make up the insulating member 9 are shown. The gate 5 includes two layers' the upper electroconductive layer 5a and the lower electroconductive layer 5b. In addition, a plurality of cathodes 6a each having a strip shape are formed on the side wall face of the first insulating layer 3. The cathode 6a is made from an electroconductive material and is electrically connected with the device electrode 2. On the other hand, the gate auxiliary layer 6b makes up one part of the gate 5, and is formed on a region from the top face of the gate 5 to the tip face (side wall face) of the gate 5 so as to be arrayed in line with the cathode 6a. A plurality of the layers is formed. The gate auxiliary layer 6b is formed from the same electroconductive material as that of the cathode 6a, and is electrically connected to the gate 5.

The recess portion 7 is formed by retreating the side wall face of the second insulating layer 4 in the side wall face of the insulating member 9 so as to recess the side wall face toward the inner part compared to the tip face of the gate 5 and the side wall face of the first insulating layer 3. A gap 8 is also shown in which an electric field necessary for an electron emission is formed. The gap 8 is extremely narrow and is formed so as to be generally uniform in a transverse direction of the device, in other words, in a direction from left to right in FIG. 12C.

The basic production method is similar to that in Exemplary embodiment 3, so that only the difference between the methods will now be described below with reference to FIG. 11.

In the present exemplary embodiment, molybdenum (Mo) of the cathode material 6 was deposited on the gate 5 with a sputtering vapor-deposition method. The angle of the substrate 1 in film formation was set so as to be horizontal with respect to a sputtering target. An argon plasma was generated at a vacuum degree of 0.1 Pa so that sputtered particles were incident on the surface of the substrate 1 at a limited angle, and the substrate 1 was set so that the distance between the substrate 1 and the Mo target could be 60 nm or less (mean free path of argon ion at 0.1 Pa). The vapor deposition operation was carried out at a fixed deposition speed of approximately 10 nm/min for approximately 2 minutes to form the film of Mo into the thickness of 20 nm on the side wall face of the first insulating layer 3 (outer surface of insulating member 9). At this time, the film was formed so that the amount of the cathode material 6 simultaneously formed in the recess portion 7 could be 40 nm.

After the molybdenum film was formed, a resist pattern having the line width and space width of 3 μm was formed on the cathode materials 6a′ and 6b′ with a photolithographic technology. Subsequently, the cathode 6a and the gate auxiliary layer 6b which makes up one part of the gate 5 were formed, by processing both films of the cathode materials 6a′ and 6b′ with a dry etching technique and removing an unnecessary resist. A processing gas used at this time was a CF₄-based gas so as to suit molybdenum of the cathode material 6.

The electrode widths T1 and T2 of the obtained cathode 6a and the gate auxiliary layer 6b illustrated in FIGS. 12A and 12C were measured. As a result, the electrode width T2 of the gate auxiliary layer 6b was approximately 10 nm to 30 nm narrower than the electrode width T1 of the cathode 6a in a low potential side.

As a result of having analyzed the cross section with a TEM, the average value of the gap 8 between the cathode 6a and the gate 5 (gate auxiliary layer 6b) in FIG. 12B was 8.5 nm.

The present exemplary embodiment also showed a similar advantage as in Exemplary embodiment 2. Furthermore, an electron beam source with higher efficiency could be formed by providing a plurality of the gate auxiliary layers 6b on the gate 5 and setting the width (T2) so as to become smaller than the width (T1) of the cathodes 6a which were also provided in plural numbers.

In addition, the above described image display apparatus was prepared by using each electron-emitting device in the above described Exemplary embodiments 2 and 4. As a result, the display apparatus having an excellent formability of an electron beam could be provided, and consequently the display apparatus showing an adequately displayed image could be realized.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-231028, filed Sep. 9, 2008, which is hereby incorporated by reference herein in its entirety.

What is claimed is:

1. An electron beam device comprising:
an insulating member having a recess portion on a surface of the insulating member;
a cathode having a protrusion extending over an outer surface of the insulating member and an inner surface of the recess portion;
a gate arranged on the outer surface of the insulating member, the gate facing the protrusion; and
an anode facing the protrusion via the gate,
wherein the gate comprises a layered structure having at least two electroconductive layers, and a thermal expansion coefficient of one of the electroconductive layers that is arranged at a portion facing the protrusion is larger than a thermal expansion coefficient of rest of the electroconductive layers.

2. The electron beam device according to claim 1, wherein a material of the rest of the electroconductive layers is the same as a material of the cathode.

3. The electron beam device according to claim 1 comprising a plurality of the cathodes.

4. The image display apparatus comprising: at least one electron beam device of claim 1; and at least one light emission member arranged on the anode.
